(19) United States
(12) Patent Application Publication
(10) Pub. No.: US 2013/0020539 A1
(43) Pub. Date: Jan. 24, 2013

(54) Type of multiband solar cells made of europium chalcogenides

(71) Applicant: Zhixun Ma, Richmond, CA (US)

(72) Inventor: Zhixun Ma, Richmond, CA (US)

(21) Appl. No.: 13/188,404

(22) Filed: Jul. 21, 2011

(51) Int. Cl. H01B 1/02; H01B 1/08; C01F 17/00; C22C 5/04; C22C 21/00; C22C 28/00; C22C 11/00; C22C 5/02; H01B 1/10; C01G 19/02

(52) U.S. Cl. 252/519.14; 252/519.4; 252/521.1; 423/263; 423/594.9; 420/528; 420/555; 420/563; 420/507; 420/466

(57) ABSTRACT

A novel multiband absorption based solar cell is disclosed by using the europium chalcogenides (EuX, X═O, S, Se, Te) and related magnetic semiconductor materials, in which an intermediate band is formed by the localized Eu 4f electrons between p-states of chalcogen ions and Eu s-d states. The energy gaps among the multibands can be in the spectral range of the sunlight, thus they can serve as better sunlight absorbers in solar cells than the conventional single band-gap semiconductors such as Si and GaAs. With these multiband semiconductors, the bottleneck in current power conversion efficiency can be potentially overcome in single junction photovoltaics.

### BACKGROUND OF THE INVENTION

The present invention relates to new materials for photovoltaic devices and more specifically multiband semiconductors for high conversion efficiency from solar to electricity.

There are many factors to determine whether a material is suitable for making solar cells, such as the band gap energy, light absorption coefficient, doping concentration, and mobility and lifetime of minority carrier. Among these, the band gap energy is of primary importance since solar spectrum distributes in a wide energy range, roughly from 0.62 to 4.1 eV with a maximum at around 2.5 eV. Theoretical calculation indicates that for a single semiconductor material, the maximum of the band-gap limited efficiency corresponds to a band gap of 1.07 eV for AM0 and 1.0-1.4 eV for AM1.5. Therefore, Si (1.12 eV), GaAs (1.42 eV), CdTe (1.50 eV), and CuInGaSe₂ (1.01-1.64 eV) are the good candidates for solar cells. A conventional solar cell utilizes a p-n junction formed by doping with p- and n-type dopants to absorb the sunlight and produce electricity. However, such a single junction solar cell has only limited conversion efficiency because they are only sensitive to a limited part of the total solar spectrum. The efficiency can be improved by stacking several p-n junctions formed with semiconductors of different band gap energies that are sensitive to different parts of solar spectrum. By using thin film technology, this concept has been realized in multijunctions or tandem solar cells such as AlGaAs/GaAs two-junction cascade solar cell prepared by MOCVD [B-C. Chung, G. F. Virshup, and J. G. Werthen, Appl. Phys. Lett. 52, 1889 (1988)], a-Si/a-GeSi tandem solar cell [J. Yang, A. Banerjee, and S. Guha, Appl. Phys. 70, 2975 (1997)] and a-Si/μc-Si tandem solar cell [Y. Mai, S. Klein, R. Carius, H. Stiebig, X. Geng, and F. Finger, Appl. Phys. Lett. 87, 073503 (2005)]. Currently, the efficiency of the a-Si based triple junction solar cell has been over 13%, and the efficiency of III-VI based triple junction solar cell is 37.9%. However, the technical complexity and high cost hinder their applications.

The inherent disadvantage of low infrared absorption in these semiconductors essentially limits the performance of the solar cells. Another way to increase the efficiency of solar cells is to introduce an impurity energy level within the band gap that absorbs additional lower energy photons [Jianming Li, Ming Chong, Jiancheng Zhu, Yuanjing Li, Jiadong Xu, Peida Wang, Zuoqi Shang, Zhankun Yang, Ronghua Zhu, and Xiolan Cao, Appl. Phys. Lett. 60, 2240 (1992)]. The theoretical efficiency of this multiband solar cell can reach to over 60%, which is much greater than that of the solar cells with a single band gap [Antonio Luque and Antonio Marti, Phys Rev. Lett. 78, 5014(1997)]. Semiconductors with an intermediate band can absorb different parts of the sunlight in wavelength and can maximize the total absorption energy, but it is difficult to realize this concept practically. The dilemma is that the electric transport properties will be deteriorated by the impurities that could produce an intermediate band in a semiconductor. The problem is how to introduce an intermediate in a semiconductor without loss of its crystal quality.

Recently, it has been found that the intermediate band can emerge from conduction band into band gap of nitrogen doped III-V [J. Wu, W. Shan and W. Walukiewicz, Semiconductor Science and Technology 17, 860 (2002)] and oxygen doped II-VI [K. M. Yu, W. Walukiewicz, J. Wu, J. W. Beeman, J. W. Ager, E. E. Haller, I. Miotkowski, A. K. Ramdas, and P. Becla, Appl. Phys. Lett. 80, 1571 (2002)] semiconductors via band anticrossing interaction between localized O or N states and the extended states of the semiconductor matrix [W. Walukiewicz, W. Shan, K. M. Yu, J. W. Ager III, E. E. Haller, I. Miotlowski, M. J. Seong, H. Alawadhi, and A. K. Ramdas, Phys. Rev. Lett. 85, 1552 (2000)]. Even if theoretical calculation predicts that the efficiency of solar cells made from these dilute doped semiconductors could reach beyond 50%, the prospect is still unclear because of the complexity in material preparation and material deterioration with introduction of alien elements.

Is there a semiconductor in which an intermediate band exists intrinsically? Fortunately, europium chalcogenides possess this property. With NaCl-type crystal structure, europium chalcogenides (EuX, X═O, S, Se, Te) form a very interesting series due to their varieties of electronic and magnetic properties, but the common feature is that the divalent Eu ions possesses very large local moment from the half filled 4f band. A gap separates the 4f band from 5d6s conduction bands. The experimental electronic gap energies are 1.12, 1.65, 1.80, and 2.0 eV for EuO, EuS, EuSe and EuTe, respectively, at room temperature. The p-states of the chalcogen ions are located below 4f band, and therefore an intermediate band is formed by the 4f band between p-states and 5d6s states in these semiconductors. The relative position of the 4f band varies with X. These band gap energies as well as interband transition energies fall into the solar radiation energy range (see FIGS. 1 and 2). The multiband feature and the interband transition energies make the Eu chalcogenides very good candidates for solar cell applications. There are several advantages over the current solar cell materials: (1) Compared to the N-doped III-V and O-doped II-VI semiconductors aforementioned, the possession of multiband in Eu chalcogenides is intrinsic in the Eu chalcogenides, no doping is necessary; (2) They have much higher absorption coefficient than silicon and GaAs (see FIG. 4); (3) The carrier lifetime in Eu chalcogenides is much longer (10⁻¹<τ<10⁻² second) than that in silicon (ms) and GaAs (ns). Therefore, the solar cells made with these Eu chalcogenides will have much better device performance.

### SUMMARY OF THE INVENTION

This invention provides a new series of multiband gap semiconductor materials used for designing high efficiency solar cells based on thin film technology. These materials include EuO, EuS, EuSe, EuTe, PbₓEu₁₋ₓTe, and their alloys. The localized 4f states of Eu are located inbetween 5d6s states of Eu and valence p states of chalcogen ions, especially for EuO and EuS in which the 4f states are completely separated from 5d6s and p states. The enhanced absorption coefficient by the multiband absorption and the appropriate band gap energies make these material good candidates for solar cell manufacturing. These materials can be fabricated by molecular beam epitaxy, sputtering, evaporating, and pulsed laser deposition techniques. The p-n junctions can be deposited on lattice matched or unmatched substrates.

### DESCRIPTION OF THE DRAWINGS

FIG. 1 shows the density of states of EuX (X═O, S, Se and Te). With a width of about 1 eV, the 4f band is located in the middle of the 6s5d bands and p-band. The measured band gaps are 1.12, 1.65, 1.80, and 2.0 eV for EuO, EuS, EuSe and EuTe, respectively, which are quite well within the solar spectrum.

FIG. 2 shows the multi-absorption of Pb_{0.2} Eu_{0.8}Te from the literature of Physical Review B 60, 8117 (1999).

FIG. 3 shows solar radiation spectrum at the top of atmosphere (yellow) and at the sea level (red). The dips on the red are due to the absorption of the air. On the right panel schematically shows an example of optical absorptions in the multi-band semiconductor EuO. The three absorption energies almost cover all the solar radiation energy range.

FIG. 4(a) shows the absorption coefficient of EuX as function of photon energy. The absorption coefficients of Si and GaAs in FIG. 4(b) are shown for comparison. The absorption coefficient of EuX is two orders of magnitude higher than silicon and one order of magnitude higher than GaAs in solar spectrum range.

FIG. 5 shows the p-n junction types, which depend on the dopant location. The acceptor level is located closely above 4f band (a) and closely above p-band (b) in p-type side.

FIG. 6 shows a p-i-n junction solar cell using Eu chalcogenides multiband semiconductors as absorber in i-layer.

### DESCRIPTION OF THE PREFERRED EMBODIMENTS

This invention provides a general principle of fabricating multiband solar cells using Eu chalcogenides. A specific embodiment herein is subject to be modified based on further understanding and investigations of such kind of semiconductors and solar cells, such as doping and cell design.

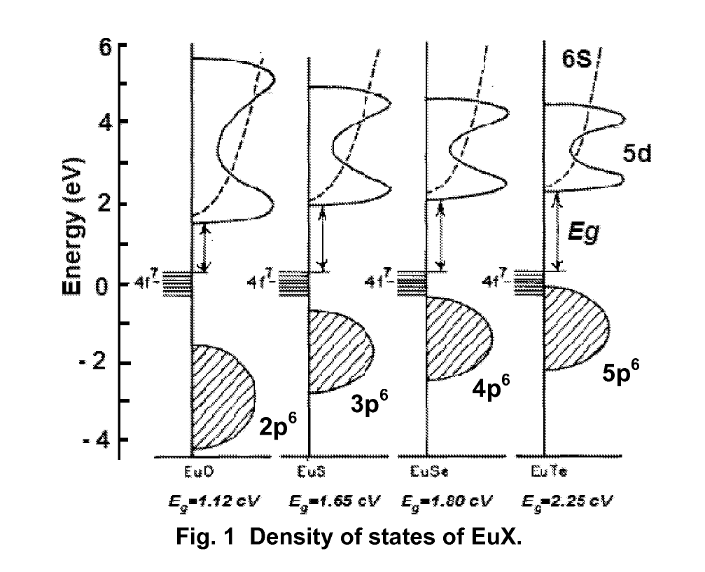

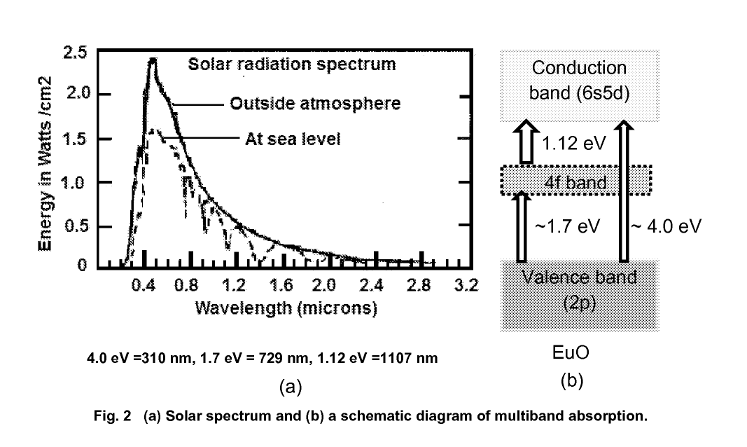

This invention provides a series of semiconductor materials with intrinsic multi-bands (without additional doping) for designing solar cells since the multi-absorption energies are located in spectral range of solar radiation, as shown in FIG. 1 and FIG. 2. For example, the band gap of EuO is 1.12 eV at room temperature, which is the same as silicon, one of the best materials in band gap energy for solar cell.

This invention provides a series of semiconductor materials whose interband transition energies can be tuned by alloying of these materials, e.g., EuO₁₋ₓSₓ, EuO₁₋ₓSeₓ, and PbₓEu₁₋ₓTe, in order to maximize the total absorption of the solar energy.

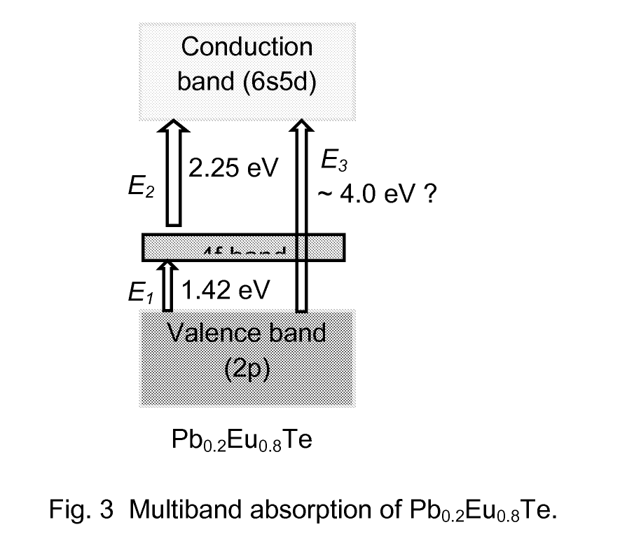

In one embodiment of the present invention there is disclosed a semiconductor composition comprising a ternary PbₓEu₁₋ₓTe alloy. The band gap of PbₓEu₁₋ₓTe can is changeable in a wide range from 0.19 to 2.25 eV, with a multiple interband absorption for 0<x<0.2 and a single interband absorption for x>0.2. For Pb_{0.2}Eu_{0.8}Te, the two absorption happens at E₁=1.42 eV and E₂=2.25 eV, the former transition comes from lower valence band to Eu 4f band, while the later is from 4f band to conduction band transition (EuTe-like transition), as shown in FIG. 3. The energy of 1.42 eV is exactly as same as that of GaAs band gap at room temperature, which is another best band gap for solar cell. The E₁ can be tuned to higher energies with decreasing x, in order to increase the absorption of the infrared light.

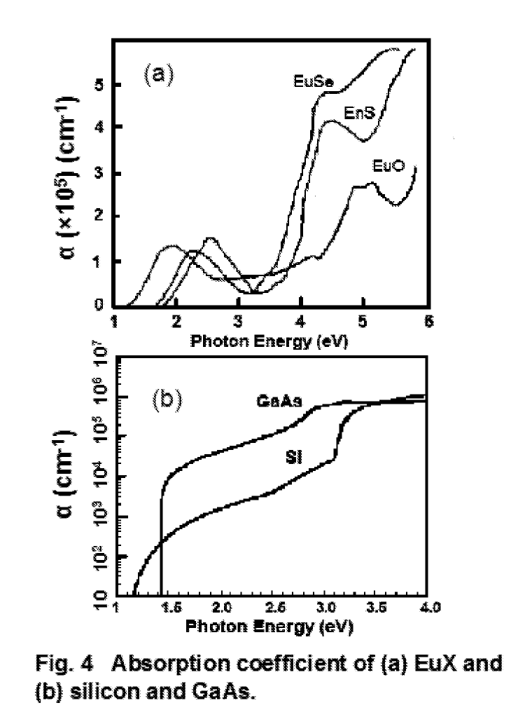

The absorption coefficients of EuX (FIG. 4) are much larger than those of Si and GaAs, which are dominant materials in photovoltaic technology and semiconductor industries. Therefore, the conversion efficiency of the solar cells made of EuX with multibands can be much larger than that of solar cells made by other conventional semiconductor materials.

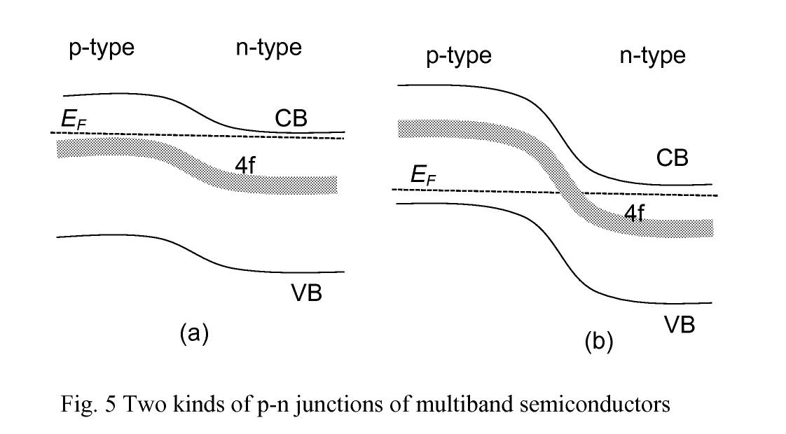

In one embodiment of the present invention the n-type EuO can be obtained by substituting Eu with trivalent Gd or other rare earth ions such as La, Ce, Dy, Ho, and Lu. The n-type EuO can also be obtained with excess Eu (O vacancies). The other EuX of n-type materials can be obtained in a similar way like EuO. The p-type EuX can be obtained with Eu vacancies (excess X), or by substituting O with single valent anion such as Cl and F. However, the conductivity of such p-type EuX is much higher than that of n-type EuX because the large hole mass at the top of the 4f band, but it can be improved if the acceptor level is located in the vicinity of the p-state band. As shown in FIG. 5, two type of p-n junction is formed with different acceptor levels.

Eu oxides include EuO and Eu₃O₄. Eu₃O₄ also has multiband energy structure [Phys. Rev. B 12, 3940 (1975)].

All of the compositions disclosed herein are suitable for films for use in photovoltaic devices.

The thin films and solar cells of the mentioned materials in this invention can be obtained by sputtering, pulsed laser deposition, evaporation, and molecular beam epitaxy, etc.

Eu chlcogenide alloys mean to include all compound semiconductor materials composed of EuO, EuS, EuSe and EuTe binary, ternary and quaternary alloys of the respective group elements. The alloy or dopants also include most of the elements of lanthanides like La, Ce, Sm, Eu, Gd, Tb, Dy, Er, Tb, Lu, etc. Since the electron affinity energy of the Eu chalcogenides is quite small, for n-type Eu chalcongenides, the metals (rare earth metals) with low workfunction, or heavily doped semiconductors can be used as ohmic contact materials.

In the present invention the materials include doped and undoped alloys and may be arranged to form a variety of semiconductor devices with junctions like p-n, p-i-n, p-n-p-n and so on. The photovoltaic devices include two junction and triple junction structures (i.e. tandem solar cells).

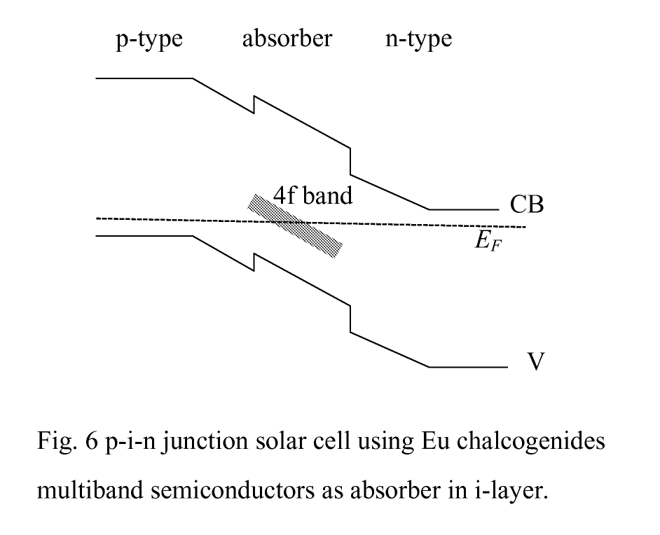

Most importantly, p-i-n structures, as shown in FIG. 6, the Eu chalcogenides can be used as an effective absorber in i-layer, which is sandwiched within a p-n junction formed by the other semiconductors such as Si, GaAs, and CdTe, etc.

The invented method and designed solar cell devices are applicable for manufacturing high efficiency thin film solar cell. It will be understood that various modifications and changes may be applied to the present invention without deviating from the spirit and scope thereof.

We claim:

1. Europium Chalcogenides include: EuO, Eu₃O₄, EuS, EuSe, EuTe as well as PbₓEu₁₋ₓTe (0<x<0.2).

2. The Europium Chalcogenide semiconductors of claim 1, wherein the n-type is formed by gadolinium doping and excess europium or other dopants.

3. The Europium Chalcogenide semiconductors of claim 1, wherein the p-type is formed by excess chalcogen elements: O, S, Se and Te, or other dopants.

4. The ohmic contacts for the semiconductors of claim 1: Al, In, Pb for the n-type and ITO, Au or Pt for p-type.

5. A photovoltaic device comprising the EuO in claim 1.

6. A photovoltaic device comprising the Eu₃O₄ in claim 1.

7. A photovoltaic device comprising the EuS in claim 1.

8. A photovoltaic device comprising the EuSe in claim 1.

9. A photovoltaic device comprising the EuTe in claim 1.

10. A photovoltaic device comprising the PbₓEu₁₋ₓTe (0<x<0.2) in claim 1.

11. Photovoltaic devices comprising the aforementioned alloys, p-type, n-type and undoped aforementioned alloys in claim 1.
